(19) United States
(12) Patent Application Publication
(10) Pub. No.: US 2008/0047014 A1
(43) Pub. Date: Feb. 21, 2008

(54) Computer information protecting method

(76) Inventor: Horng Jien Chou, Taichung (TW)

Correspondence Address: CHARLES E. BAXLEY, ESQ., 90 JOHN STREET, THIRD FLOOR, NEW YORK, NY, 10038, US

(21) Appl. No.: 11/635,120

(22) Filed: Dec. 6, 2006

Related U.S. Application Data
(63) Continuation-in-part of application No. 11/497,963, filed on Aug. 2, 2006.

(51) Int. Cl. G06F 12/14

(52) U.S. Cl. 726/24

(57) ABSTRACT

A method for protecting information in a computer facility includes coupling a protecting device between the computer facility and an input device, and coupling a storing media to the input device in order to intercept a pure information entering into the computer facility, and the information may be stored in the storing media for allowing the information entered with the input device to be sent to the computer facility to revive the computer facility. The input device may be coupled to the protecting device and then coupled to the input device, or directly coupled between the computer facility and the input device. The protecting device may be disposed in or out of the computer facility.

The present invention is a continuation-in-part of U.S. patent application Ser. No. 11/497,963, filed 2 Aug. 2006, now pending.

### BACKGROUND OF THE INVENTION

1. Field of the Invention

The present invention relates to a data or information protecting method, and more particularly to a computer data or information protecting method for protecting the working data or files or information and for allowing the damaged working data or files or information to be quickly revived.

2. Description of the Prior Art

Typical computer facilities may have the memories or other working files damaged or killed by various kinds of computer viruses and may have the computer facilities become failed. After that, the users have to spend a lot of time to rebuild the data or files or information that have previously been built, and most of the data or files or information may not be recovered such that the users may waste much time in rebuilding or rewriting the data or files or information.

Various kinds of computer viruses have been developed and may damage the computer facilities, for example, may damage the operating system of the computer facilities, may damage the data or files or information stored in the hard discs of the computer facilities, or may have the data or files or information stored in the hard discs of the computer facilities be stolen by the other unauthorized persons.

Now, various kinds of anti-virus software have been developed for selected or specific kinds of computer viruses and for killing only the selected or specific kinds of computer viruses. However, many other new computer viruses may have been developed everyday such that the previous provided or developed anti-virus software may not be used to kill the newly built or developed computer viruses.

The other method for protecting the working data or files or information is to copy and store or backup the previous built or written data or files or information which may be used to restore or revive the damaged working data or files or information after the memories or the working files of the computer facilities have been damaged or killed by various kinds of computer viruses.

However, after copying and storing the previous built or written data or files or information and before the computer facilities have been damaged by the computer viruses, much of the data or files or information that have been worked hard by the users may also be damaged or killed by various kinds of computer viruses.

U.S. Pat. No. 6,330,648 to Wambach et al. discloses one of the typical methods for protecting the computer memories with an anti-virus and anti-overwrite protection apparatus which includes a controller card for coupling to the computer processor and the motherboard, and the controller card includes a write protection circuit operated independently for preventing any write requests specifying the memory locations contained in the list from being carried out, and includes a manual protect enable switch for enabling and temporarily disabling the write protection circuit.

However, some of the data or files or information that have been worked hard by the users may also be damaged or killed by various kinds of computer viruses before the computer viruses have been found.

The present invention has arisen to mitigate and/or obviate the afore-described disadvantages of the conventional data or information protecting methods.

### SUMMARY OF THE INVENTION

The primary objective of the present invention is to provide a data or information protecting method for protecting the working data or files or information and for allowing the damaged working data or files or information to be quickly revived.

In accordance with one aspect of the invention, there is provided a method for protecting information in a computer facility, the method comprising providing and coupling a protecting device between the computer facility and an input device, disposing the protecting device in or out of the computer facility, providing and coupling a storing media to the input device, intercepting an information entering into the computer facility with the input device, and storing the information entered with the input device in the storing media, for allowing the information entered with the input device to be sent to the computer facility when the computer facility is damaged.

The input device may be coupled to the protecting device and then coupled to the input device, or directly coupled between the computer facility and the input device for intercepting the information entering into the computer facility with the input device.

The protecting device includes a processing device coupled between the computer facility and the input device for allowing the computer facility to be worked or operated in the conventional way indirectly via the protecting device.

The protecting device includes a temporary storing area coupled between the computer facility and the input device. The protecting device includes a function key information area coupled to the computer facility.

The input device may be coupled to the protecting device wirelessly or with wires or cables. The protecting device may also be coupled to the computer facility wirelessly or with wires or cables.

The computer facility further includes a mainboard, and the protecting device is disposed in the mainboard of the computer facility.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating a facility to be protected with a data or information protecting method in accordance with the present invention;

FIG. 2 is another plan schematic view illustrating a portion of the facility to be protected with a data or information protecting method;

FIG. 3 is a further plan schematic view illustrating the detailed structure of the facility to be protected with a data or information protecting method;

FIG. 4 is a still further plan schematic view illustrating the other portion of the facility to be protected with a data or information protecting method;

FIG. 5 is a plan schematic view illustrating the coupling of the protecting device to the facility to be protected;

FIG. 6 is another plan schematic view similar to FIG. 5, illustrating the other coupling arrangement of the protecting device to the facility to be protected; and

FIG. 7 is another plan schematic view similar to FIGS. 5 and 6, illustrating the further coupling arrangement of the protecting device to the facility to be protected.

### DETAILED DESCRIPTION OF THE PREFERRED EMBODIMENT

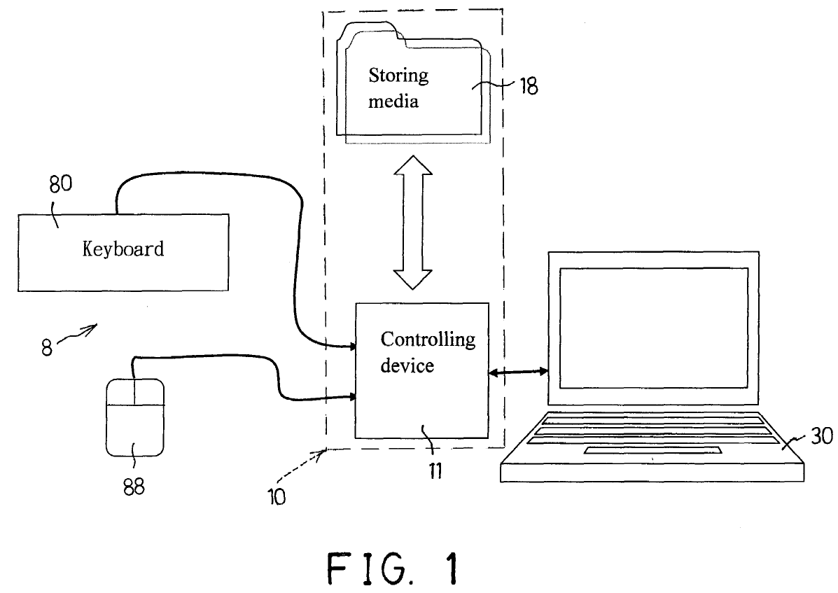

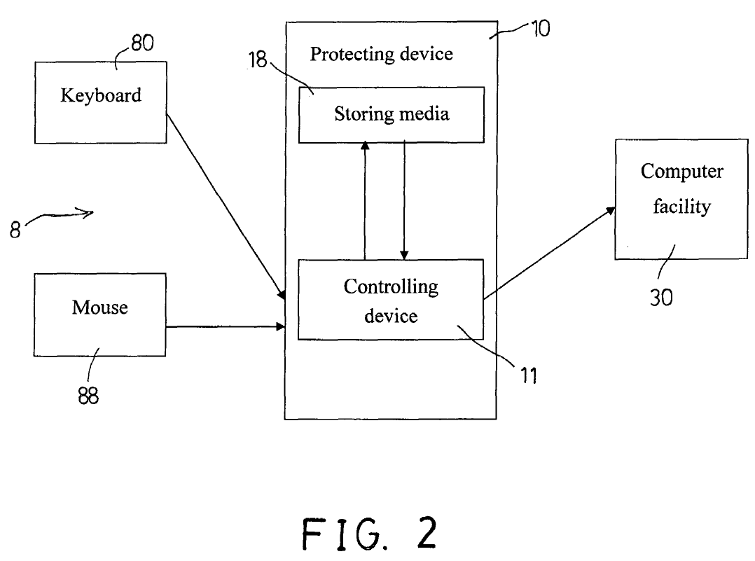

Referring to the drawings, and initially to FIGS. 1-3, a data or information protecting method in accordance with the present invention comprises preparing and providing a separating or protecting device 10 which is to be coupled to a computer facility 30 and also to be coupled to an entering or writing or input device 8, the input device 8 may include a keyboard 80, a mouse 88, a vocal or speech input device (not shown), and/or an optical input device (not shown), or other entering or writing devices, for allowing the protecting device 10 to be disposed or coupled between the computer facility 30 and the input device 8, or for separating the computer facility 30 and the input device 8 from each other.

The protecting device 10 includes a controlling device 11 to be disposed or coupled between the computer facility 30 and the input device 8 with electric wires or cables or wirelessly with radio or infrared emitting and/or receiving devices (not shown). It is to be noted that the keyboard 80 or the mouse 88 of the input device 8 are the original entering or writing tools or devices and may normally be used for one-way keying or writing or sending or entering data or information into the computer facility 30 such that the input device 8 will not be damaged by the computer viruses, and such that the data or information keyed or written or sent or entered by the input device 8 will be intercepted by the controlling device 11 and may become the pure or clean data or information and also will not be damaged by the computer viruses.

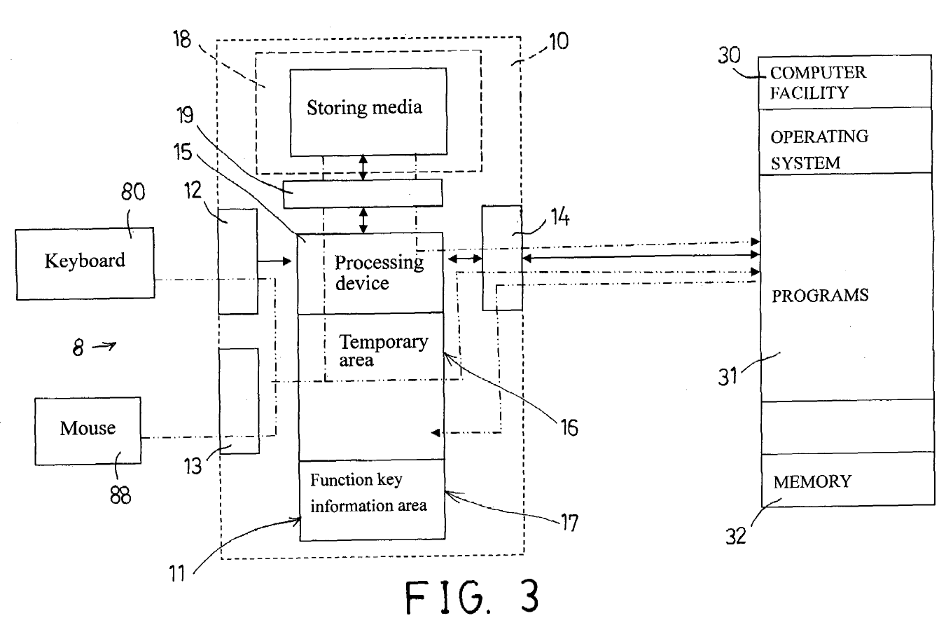

As shown in FIG. 3, the controlling device 11 includes one or more (such as two) terminals 12, 13 for coupling to the keyboard 80 and/or the mouse 88 of the input device 8 respectively, and another terminal 14 for coupling to the computer facility 30. The terminals 12-14 may be selected from various kinds of terminals, such as universal serial bus (USB) terminals, or the like. The controlling device 11 further includes a micro-processing or processing device 15 and a temporary storing or accessing area 16 coupled between the computer facility 30 and the input device 8 for allowing the computer facility 30 to be operated or processed with the keyboard 80 and/or the mouse 88 of the input device 8 indirectly via the controlling device 11. The controlling device 11 further includes a function key information area 17 coupled to the computer facility 30 for receiving the function key information, such as the left key, the right key, the up key, the down key, the control (CTRL) key, the ALT key, or the like from the computer facility 30.

The protecting device 10 further includes a memory or storing media 18 disposed or inbuilt in the controlling device 11, or disposed out of the controlling device 11, or disposed in the computer facility 30, and disposed or coupled between the computer facility 30 and the controlling device 11 or the input device 8 for allowing the pure or clean data or information keyed or written or sent or entered by the input device 8 also to be sent to the storing media 18 and to be memorized or stored as a spare copy in the storing media 18. It is also to be noted that the coupling between the storing media 18 and the computer facility 30 is also one-way such that the pure or clean data or information entered by the input device 8 and memorized or stored in the storing media 18 will not be damaged by the computer viruses.

It is also to be noted that the data or information keyed or written or sent or entered by the input device 8 also to be sent to the computer facility 30 in the usual way to control or to operate the computer facility 30. The computer facility 30 may also be worked or operated in the conventional way to use the programs 31 provided in the computer facility 30 and to generate the working data or files or information that may be memorized or stored in a memory or storing media 32 of the computer facility 30. The working data or files or information memorized or stored in the memory or storing media 18 may be equal to the working data or files or information memorized or stored in the memory or storing media 32 of the computer facility 30 and may be sent to the computer facility 30 to restore the memory or storing media 32 quickly when the memory or storing media 32 has been damaged by the computer viruses, for example.

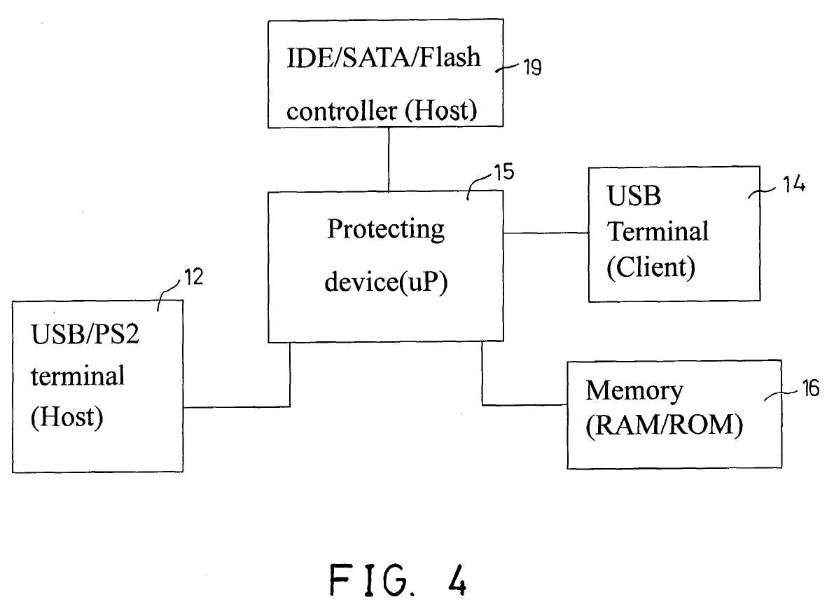

As shown in FIG. 4, the memories or storing media 18, 32 may be selected from random access memories (RAM), non-volatile memories, erasable memories, flash memories, etc., and the terminals 12, 13 may be selected from such as personal computer system 2 (PS/2) host for coupling the keyboard 80 and/or the mouse 88 of the input device 8 to the processing device 15 of the controlling device 11, an integrated drive electronics (IDE) or a serial AT attachment (SATA) or a flash controller 19 may be used for coupling the controlling device 11 to the memory or storing media 18. The terminal 14 may also be a USB terminal 14 for coupling to the computer facility 30.

In operation, when the computer facility 30 is switched on or initialized or energized, the controlling device 11 may receive the function key information, such as the left key, the right key, the up key, the down key, the control (CTRL) key, the ALT key, or the like from the computer facility 30 and stored in the function key information area 17 of the controlling device 11 for allowing the computer facility 30 to be operated or processed with the keyboard 80 and/or the mouse 88 of the input device 8 indirectly via the controlling device 11. The working procedures or data or information may be stored in the temporary storing or accessing area 16 and may then be stored in the memory or storing media 32 of the computer facility 30 any time, or when the user wishes to store the information, particularly when the computer facility 30 is warned to be attacked by a computer virus.

When the computer facility 30 has been attacked or damaged by a computer virus, the memory or storing media 32 of the computer facility 30 may be formatted, and the spare copy or the pure or clean data or information keyed or written or sent or entered by the input device 8 and memorized or stored in the storing media 18 may then be quickly sent to the memory or storing media 32 of the computer facility 30 and/or may be operated or processed with the programs 31 provided in the computer facility 30 to generate the working data or files or information again that may be memorized or stored in the memory or storing media 32 of the computer facility 30, and thus to quickly restore the data or information that have been damaged by the computer viruses.

The programs 31 may have to be copied into the computer facility 30 again when the computer facility 30 has been attacked or damaged by the computer viruses. The programs 31 may be quickly restored or copied into the computer facility 30 in the usual way. However, the copying of the programs 31 into the computer facility 30 is not related to the present invention and will not be described in further details. The storing media 18 may also be directly coupled between the keyboard 80 or the mouse 88 of the input device 8 and the computer facility 30; or coupled between the keyboard 80 or the mouse 88 of the input device 8 and the controlling device 11, for acting as an intercepting means for directly intercepting the pure or clean data or information keyed or written or sent or entered into the computer facility 30 by the input device 8.

It is further to be noted that the pure or clean data or information keyed or written or sent or entered by the input device 8 and sent to the storing media 18 and/or memorized or stored as a spare copy in the storing media 18 may further be transmitted to a monitor server or may be coupled to a monitoring circuit or program in order to detect and to monitor the work done with the input device 8, for allowing any unusual or abnormal action or operation to be found as early as possible. The input device 8 may also be shut down or switched off when the unusual or abnormal action or operation has been found, for example. The above described structure has been disclosed and filed in the co-pending U.S. patent application Ser. No. 11/497,963, filed 2 Aug. 2006 which may be taken as a reference for the present invention.

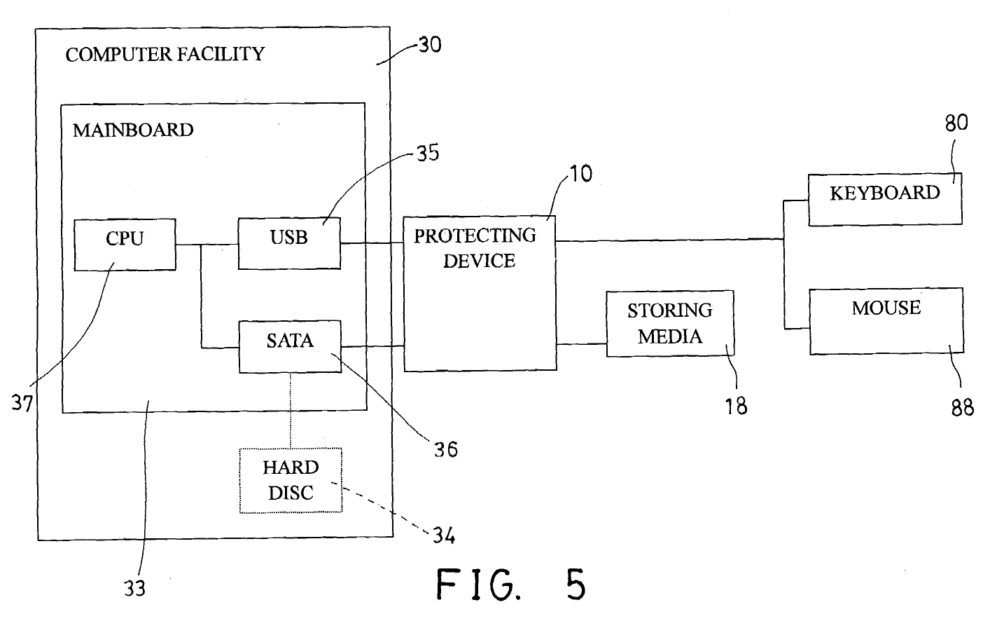

As shown in FIG. 5, the protecting device 10 may be disposed outside the computer facility 30 and coupled between the computer facility 30 and the input device 8, for example, the computer facility 30 includes a mainboard 33 having one or more memories or hard discs 34 coupled thereto, and a terminal 35, such as a universal serial bus (USB) terminal or the like 35 and a controller 36, such as a SATA controller 36 coupled to a central processing unit (CPU) 37 for coupling to the protecting device 10, for directly intercepting the pure or clean data or information keyed or written or sent or entered into the computer facility 30 by the input device 8.

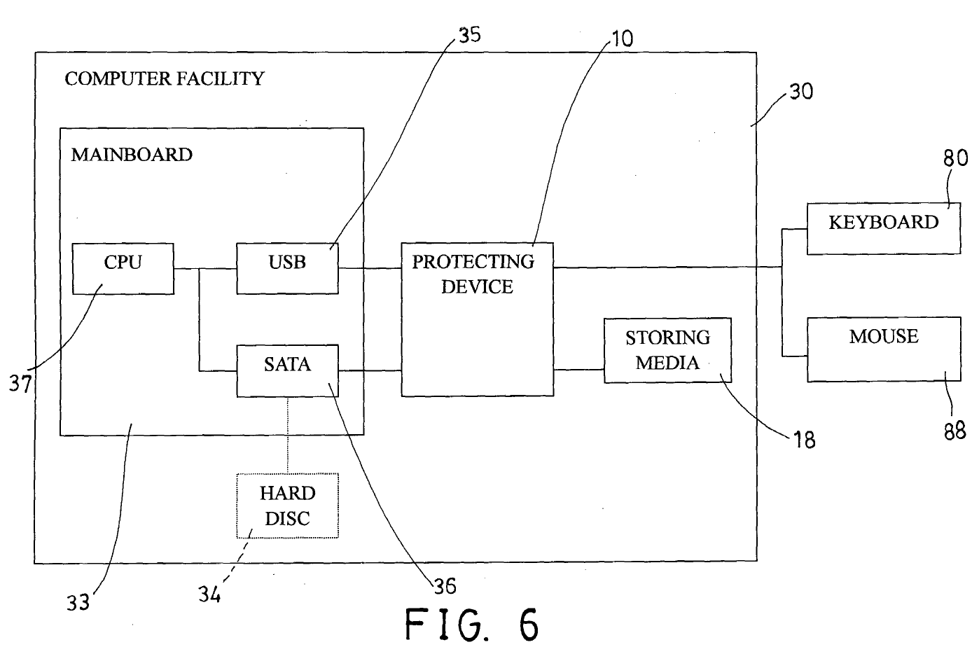

Alternatively, as shown in FIG. 6, the protecting device 10 may also be disposed inside the computer facility 30, but disposed beside the mainboard 33 and coupled between the mainboard 33 of the computer facility 30 and the input device 8 for directly intercepting the pure or clean data or information keyed or written or sent or entered into the computer facility 30 by the input device 8.

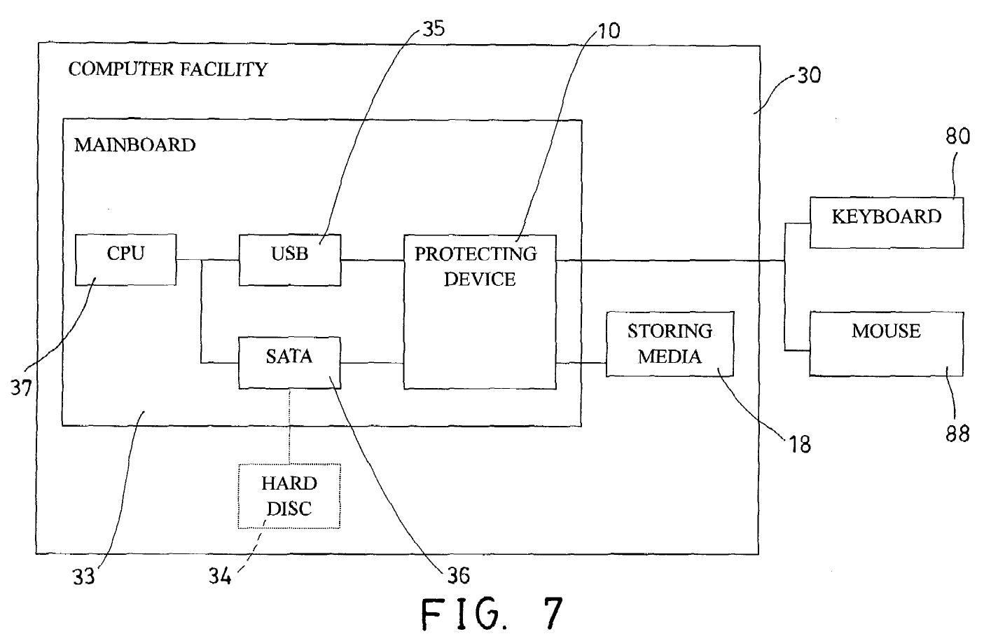

Further alternatively, as shown in FIG. 7, the protecting device 10 may also be disposed inside the computer facility 30 and disposed inside the mainboard 33 and directly coupled between the USB terminal 35 and the SATA controller 36 of the mainboard 33 and the input device 8 for directly intercepting the pure or clean data or information keyed or written or sent or entered into the computer facility 30 by the input device 8.

Accordingly, the data or information protecting method in accordance with the present invention may be provided for protecting the working data or files or information and for allowing the damaged working data or files or information to be quickly revived.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for protecting information in a computer facility, said method comprising:
providing and coupling a protecting device between said computer facility and an input device,
disposing said protecting device in said computer facility,
providing and coupling a storing media to said input device,
intercepting an information entering into said computer facility with said input device, and
storing said information entered with said input device in said storing media, for allowing said information entered with said input device to be sent to said computer facility when said computer facility is damaged.

2. The method as claimed in claim 1, wherein said input device is coupled to said protecting device.

3. The method as claimed in claim 1, wherein said protecting device includes a processing device coupled between said computer facility and said input device.

4. The method as claimed in claim 1, wherein said protecting device includes a temporary storing area coupled between said computer facility and said input device.

5. The method as claimed in claim 1, wherein said protecting device includes a function key information area coupled to said computer facility.

6. The method as claimed in claim 1 further comprising wirelessly coupling said input device to said protecting device.

7. The method as claimed in claim 1 further comprising wirelessly coupling said protecting device to said computer facility.

8. The method as claimed in claim 1 further comprising providing and disposing a mainboard in said computer facility, and disposing said protecting device in said mainboard of said computer facility.
